(19) United States
(12) Patent Application Publication
(10) Pub. No.: US 2009/0191314 A1
(43) Pub. Date: Jul. 30, 2009

(54) SYSTEM FOR GENERATING UNIQUELY FLAVORED TREATS

(76) Inventor: Nancy L. Wood, Anderson, IN (US)

Correspondence Address: Brannon & Associates PC, 1 North Pennsylvania Street, Suite 520, Indianapolis, IN, 46204, US

(21) Appl. No.: 12/019,969

(22) Filed: Jan. 25, 2008

(51) Int. Cl. A23G 3/34; A23P 1/00

(52) U.S. Cl. 426/104; 426/534; 426/519

(57) ABSTRACT

A method for encouraging the development of new flavors, wherein the method includes the steps of providing a plurality of sets of comestible pieces available for combination experimentation, providing a plurality of predetermined flavor combination suggestions, and encouraging experimental combination of comestibles from different sets. Preferably, each set is characterized by a unique flavor and the flavor of each piece is provided by a predetermined amount of flavoring contained therein. Also preferably, the predetermined amount of flavoring contained in each piece is standardized relative to flavor intensity. Optionally, rewards are given for the development or identification of successful flavor combinations.

### TECHNICAL FIELD OF THE INVENTION

The present invention relates generally to food chemistry, and more particularly, to a method for generating combination of flavors in edible nutritive compositions to create a comestible confection having a unique and individualized flavor.

### BACKGROUND OF THE INVENTION

The tastes of the consuming public vary widely. Each individual consumer has his own distinct taste preferences, and no two consumers have exactly the same taste preferences. The range of tastes varies even more widely among younger consumers, whose tastes are still developing. Moreover, many consumers, both young and old, relish the opportunity to experiment and develop new and interesting flavors. This is especially true regarding confections. However, most confectioners are forced to cater to the mainstream tastes due to production, shipping, and shelf-space limitations. There is therefore a need for a method of providing easily produced, shipped and stored confections or confection components from which a wide variety of flavors may be readily produced. The present invention addresses this need.

### SUMMARY OF THE INVENTION

The present invention relates to a system for creating customized confections, such as gum and/or candies. One object of the present invention is to generate improved flavor combinations. Related objects and advantages of the present invention will be apparent from the following description.

### DESCRIPTION OF THE PREFERRED EMBODIMENTS

For purposes of promoting an understanding of the principles of the invention and presenting its currently understood best mode of operation, reference will now be made to the embodiments illustrated in the specific language will be used to describe the same. It will nevertheless be understood that no limitation of the scope of the invention is thereby intended, with such alterations and further modifications in the illustrated device and such further applications of the principles of the invention as illustrated therein being contemplated as would normally occur to one skilled in the art to which the invention relates.

One embodiment of the present invention comprises “designer” comestibles (such as candy or chewing gum) that may be uniquely tailored to taste by an individual consumer. The comestibles are provided in a plurality of base flavors that may be combined to create more complex and individualized flavor combinations. For example, the comestibles may be formulated in therapeutic flavors such as citrus, lavender, eucalyptus and the like. Likewise, more popular flavors such as strawberry, vanilla, and chocolate may be provided. Each base comestible has a basic flavor that acts as a building block for producing a confection combination having a more complex final flavor. Preferably, the individual base comestible pieces are relatively small, such that the total mass and volume of comestibles required in combination to create more complex flavors would not be overwhelmingly large (i.e., more than a mouthful).

Preferably, each flavor would be provided in both a sugared and a sugar-free version. The sugar-free version would preferably include a non-sugar sweetener, such as sucralose or aspartame.

Each base piece is preferably shaped to interlock with other base pieces. Preferably, all pieces share the same shape and include interlocking features, such as male and female slots. Alternately, the base pieces may come in more than one shape, with some pieces shaped to interlock with most or all other pieces and others having shapes precluding interlocking with certain other predetermined shapes. Typically, the pieces interlock such that a consumer may bite into and chew all of the combined differently-flavored pieces at once so that all of the flavors may combine to produce a specific, composite flavor.

Each shape could be associated with a specific flavor or flavor family, so as to automatically discourage certain unwanted flavor combinations (such as bologna and whipped cream or chocolate-anchovy). Flavor families may be defined by flavors having shared or complimentary characteristics. These characteristics may relate to the basic taste bud receptor areas of the tongue (salty, sweet, savory, sour, bitter), be grouped according to food types (fruity, buttery, and the like), or simply according to known favored combinations.

Preferably, the base pieces each include a flavor component and a relatively unflavored or flavorless base edible component. The flavor component is typically provided in a standardized amount specific to the individual flavor, such that inherently weaker flavors are provided in greater amounts/concentrations than relatively stronger flavors. In this way, all flavors are standardized such that when combining equal number of different flavors of base pieces, one stronger flavor does not dominate.

The relatively flavorless base component is typically a chewing gum base material. Alternately, the base component may be a bubblegum base material, a soft candy base material, or a hard candy base material.

In a second embodiment, the invention contemplates a method of encouraging the combination of base flavors to discover and generate new flavors, and may incorporate elements conducive to the display and/or sale of the comestibles. The method involves displaying comestibles with different base flavor elements such that customers can select and combine the comestibles to create unique flavor combinations that suit their preferences. The comestibles are formed from a common composition so they are capable of being mixed, except that each has a different flavor. The customer may then mix and match flavors to create his own desired flavor(s). The customer may mix comestibles formulated to mimic therapeutic flavors such as citrus, lavender, eucalyptus and the like according to the directions on a menu listing predetermined suggested flavor combinations. Alternately, the customer may be free to experiment to develop his own uniquely tailored flavor combinations.

There are preferably at least thirty base flavors, more preferably at least sixty base flavors, and still more preferably at least 100 base flavors. Additionally, the present invention contemplates specialty flavors to be made available for limited times, such as seasonal or promotional flavors.

The present invention also contemplates a method of promoting the comestibles including the establishment of contests with prizes for such things as the best new flavor combination, the best flavor combination made with a specific or limited number of base pieces, the best name for a flavor, and the like. In this way, optimal flavor combinations may be developed and identified. The present invention also contemplates varying the shapes of the base pieces and/or the packaging to include educational shapes such as geometric shapes, animal shapes, jigsaw puzzle shapes, and the like

In operation, new flavor combinations may be developed by providing a plurality of sets of comestible pieces available for combination experimentation (where the pieces of a given set are typically similarly flavored and where different sets to be combined are typically differentiated according to like or complimentary characteristics), providing a plurality of predetermined flavor combination suggestions (which may be in the form of written instructions or inherent in the distinctions between the sets), and encouraging experimental combination of comestibles from different sets to define a composite set characterized by a unique flavor. Typically, the flavor of each piece is provided by a predetermined amount of flavoring contained therein, which is more typically standardized relative to flavor intensity. Rewards may be given for successful flavor combinations.

The sets may be further segregated into flavor families such that individual pieces from the sets of each family are configured exclusively to interlock with each other, and to not interlock with the pieces of other families. Further, a common family of flavors may be defined to include flavors that are more ubiquitous or universal, such as vanilla and the like. The members of the common family may be shaped so as to interlock with most or all other families.

While the invention has been illustrated and described in detail in the foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nearly infinite number of insubstantial changes and modifications to the above-described embodiments and that it would be impractical to attempt to describe all such embodiment variations in the present specification. Accordingly, it is understood that all changes and modifications that come within the spirit of the invention are desired to be protected.

What is claimed is:

1. A method for encouraging the development of new flavors, comprising the steps of:
a) providing at least 30 different sets of comestible pieces available for combination experimentation;
b) providing a plurality of predetermined flavor combination suggestions; and
c) encouraging experimental combination of comestibles from different sets;
wherein each set is characterized by a unique flavor;
wherein the flavor of each piece is provided by a predetermined amount of flavoring contained therein;
wherein the predetermined amount of flavoring contained in each piece is standardized relative to flavor intensity; and
wherein rewards are given for successful flavor combinations.

2. The method of claim 1 wherein each piece further comprises a substantially flavorless base portion and a flavoring portion.

3. The method of claim 2 wherein each piece is a gum.

4. The method of claim 2 wherein each piece is a soft candy.

5. The method of claim 1 wherein the sets are further segregated into flavor families and wherein individual pieces from the sets of each family are configured exclusively to interlock with each other.

6. The method of claim 5 wherein the pieces of each family are configured so as to not interlock with the pieces of other families.

7. A method of promoting the development of new flavor combinations, comprising;
a) providing a plurality of sets of comestible pieces available for combination experimentation;
b) segregating the plurality of sets into a number of different flavor families;
c) providing a plurality of predetermined flavor combination suggestions; and
d) encouraging experimental combination of comestibles from different flavor families;
wherein each set is characterized by a unique flavor;
wherein the pieces of each set are generally configured to interlock with the other pieces of the respective set;
wherein the flavor of each piece is provided by a predetermined amount of flavoring contained therein; and
wherein the predetermined amount of flavoring contained in each piece is standardized relative to flavor intensity.

8. The method of claim 7 wherein experimentation is encouraged within families and discouraged between families.

9. The method of claim 7 wherein the pieces of each family are configured exclusively to interlock with each other.

10. The method of claim 7 wherein the pieces of different families are configured so as to not interlock with the pieces of other families.

11. The method of claim 7 further comprising a common family of flavors, wherein the pieces of the common set are configured to interlock with each of the other families.

12. A confection, comprising in combination:
a first set of flavored comestible pieces; and
a second set of flavored comestible pieces;
wherein each set of flavored comestibles has a different flavor; and
wherein the flavor of each comestible piece is standardized according to flavor intensity.

13. The confection of claim 12 wherein the comestible pieces are configured to interlock with each other.

14. The confection of claim 12 further comprising a plurality of sets of flavored comestible pieces;
wherein the sets are segregated into a number of different flavor families;
wherein the pieces of each set are generally configured to interlock with the other pieces of the respective set;
wherein the flavor of each piece is provided by a predetermined amount of flavoring contained therein;
wherein the pieces of each family are configured exclusively to interlock with each other; and
wherein the pieces of different families are configured so as to not interlock with the pieces of other families.
